(19) United States
(12) Patent Application Publication
(10) Pub. No.: US 2024/0182051 A1
(43) Pub. Date: Jun. 6, 2024

(54) Apparatus and Method for Dynamically Matching an Operator Electronic Control Unit of a Vehicle to a Current Functional State of Vehicle Functions

(71) Applicant: Bayerische Motoren Werke Aktiengesellschaft, Muenchen (DE)

(72) Inventors: Thomas HILGER, Iffeldorf (DE); Boris ISRAEL, Muenchen (DE); Christian KNOLL, Muenchen (DE); Felix LAUBER, Muenchen (DE); Desiree MEYER, Stockdorf (DE); Stephan MUELLER, Muenchen (DE); Frederik PLATTEN, Muenchen (DE)

(21) Appl. No.: 18/499,834

(22) Filed: Nov. 1, 2023

(30) Foreign Application Priority Data
Dec. 1, 2022 (DE) 10 2022 131 854.0

(51) Int. Cl. B60W 50/08

(52) U.S. Cl. CPC B60W 50/085; B60W 2554/4041

(57) ABSTRACT

Systems, methods, and apparatuses are provided for dynamically matching an operator electronic control unit of a vehicle to a current functional state of vehicle functions of the vehicle. An electronic control unit is configured to ascertain a scope of functions of the vehicle, ascertain operating parameters of the vehicle that can influence an availability of at least one vehicle function that is part of the ascertained scope of functions of the vehicle, ascertain a current functional state of the operator electronic control unit from the ascertained scope of functions and the operating parameters, control the operator electronic control unit in such a way that the ascertained functional state can be output by the operator electronic control unit.

### CROSS REFERENCE TO RELATED APPLICATION

This application claims priority under 35 U.S.C. § 119 from German Patent Application No. 102022131854.0, filed Dec. 1, 2022, the entire disclosure of which is herein expressly incorporated by reference.

### BACKGROUND AND SUMMARY

The present subject matter relates to an apparatus and a method for dynamically matching an operator electronic control unit of a vehicle to a current functional state of vehicle functions of a vehicle.

It is known practice to provide a multiplicity of vehicle functions in a vehicle that affords the user of the vehicle an added value. Such vehicle functions can be selected by the purchaser as special equipment during vehicle configuration, for example, and as such provided in the vehicle from the factory. Due to an associated large number of possible combinations of vehicle functions, the vehicle needs to have one or more operator electronic control units comprising a corresponding number of operator control elements in the widest variety of forms in order to allow the vehicle functions to be operated by the user of the vehicle. Such provision of operator electronic control units is cost intensive. In addition, it is known practice to provide vehicle functions only in predetermined or predeterminable countries or geographical regions or markets, whereas provision or use of these vehicle functions in other countries or geographical regions is not possible or not permitted—for example due to legal regulations. Even such market-specific vehicle functions require the operator electronic control units to be matched to, or provided for, the available vehicle functions in a market-specific manner, which is also cost intensive. Specific vehicle functions may also be able to be used or able to be activated only under predetermined or predeterminable prerequisites—for example only when specific route sections are being used by the vehicle. Such vehicle functions are normally represented on the operator electronic control unit by respective corresponding operator control elements, regardless of whether they can be operated at the given time. In addition, vehicle functions are increasingly also being implemented as software. The increasing performance of the hardware and modern architectures used in vehicles means that it is possible to enable and/or install vehicle functions in a functional unit at a later time. Such vehicle functions are known by the term “function on demand”. A disadvantage of this is that vehicle functions that can be enabled at a later time require appropriate operator control elements to be kept in the operator electronic control unit(s) even though they (initially) have no associated function. This can mean that operation of the operator electronic control unit is unclear and/or unintuitive for the user of the vehicle. This is inconvenient for the user of the vehicle and can distract the user from the active road traffic when “looking” for the operator control element for a specific vehicle function, firstly due to the large number of operator control elements that are present and secondly due to functionless operator control elements provided by the operator electronic control unit, resulting in a hazard potential for safety in road traffic. In all the aforementioned cases, different equipment variants for the operator control element therefore need to be provided and/or dead keys are accepted. Busy control panel layouts for the operator control element, in which at least some of the control panels are not functional and/or functional only under predetermined prerequisites, also contribute to poor user comprehension of the operator electronic control unit and to an unaesthetic operator control element design.

The object of the present subject matter is to provide a solution that facilitates intelligent dynamic matching of an operator electronic control unit of a vehicle to a current functional state of vehicle functions in order to increase usability of the operator control element or the associated vehicle functions and therefore safety in road traffic and in order to achieve cost advantages when providing an operator electronic control unit.

This object is achieved according to the present subject matter by the features of the independent claims. Preferred examples are the subject of the dependent claims.

The aforementioned object is achieved by an apparatus for dynamically matching an operator electronic control unit of a vehicle to a current functional state of vehicle functions of the vehicle, comprising:
an electronic control unit configured
   to ascertain a scope of functions of the vehicle;
   to ascertain operating parameters of the vehicle that can influence an availability of at least one vehicle function that is part of the ascertained scope of functions of the vehicle;
   to ascertain a current functional state of the operator electronic control unit from the ascertained scope of functions and the operating parameters; and
   to control the operator electronic control unit in such a way that the ascertained functional state can be output by the operator electronic control unit.

Within the context of the document, the term vehicle covers mobile means of transport that are used for transporting people (passenger transport), goods (goods transport) or tools (machines or aids). At least in some cases, these may be electrically driven (electric car, hybrid vehicles).

The vehicle can be controlled by a driver of the vehicle. In addition or alternatively, the vehicle may be a vehicle that drives in an automated manner at least in some cases. The term “vehicle that drives in automated manner” or “automated driving” can be understood within the context of the document to mean driving with automated longitudinal or lateral guidance or autonomous driving with automated longitudinal and lateral guidance. Automated driving can be for example driving for an extended period of time on the freeway or driving for a limited period of time when parking or maneuvering. The term “automated driving” covers automated driving with any level of automation. Illustrative levels of automation are assisted, semiautomated, highly automated or fully automated driving. These levels of automation have been defined by the German Federal Highway Research Institute (BASt) (see BASt publication “Forschung kompakt”, issue November/2012). In the case of assisted driving, the driver performs the longitudinal or lateral guidance on an ongoing basis, while the system undertakes the respective other function within certain boundaries. In the case of semiautomated driving, the system undertakes the longitudinal and lateral guidance for a certain period of time and/or in specific situations, the driver needing to monitor the system on an ongoing basis as in the case of assisted driving. In the case of highly automated driving, the system undertakes the longitudinal and lateral guidance for a certain period of time without the driver needing to monitor the system on an ongoing basis; however, the driver must be capable of taking over vehicle guidance within a certain time. In the case of fully automated driving (fully autonomous driving mode), the system can automatically cope with driving in all situations for a specific application; a driver is no longer needed for this application. The aforementioned four levels of automation correspond to SAE levels 1 to 4 of SAE standard J3016 (SAE—Society of Automotive Engineering). Furthermore, SAE J3016 also has provision for SAE level 5 as the highest level of automation, which is not included in the definition from the BASt. SAE level 5 corresponds to driverless driving, in which the system can automatically cope with all situations throughout the journey in the same way as a human driver.

The apparatus comprises an electronic control unit. The electronic control unit is configured to ascertain a scope of functions of the vehicle. The scope of functions of the vehicle can cover comprise all vehicle functions that are available in the vehicle and can be operated by way of the operator electronic control unit.

The scope of functions of the vehicle can be effected from a large volume of data. The data can comprise:
data relating to an equipment for vehicle functions of the vehicle that are present in the vehicle from the factory and can be operated using the operator electronic control unit; and/or
data relating to a market-specific configuration of vehicle functions of the vehicle that can be operated using the operator electronic control unit; and/or
data relating to a user-specific availability of vehicle functions that can be operated using the operator electronic control unit, a user of a vehicle being able to “deactivate” a vehicle function that is present or available in the vehicle but that he or she does not wish to use, for example using an input and output unit in the vehicle and/or using an application that can be loaded and executed by a mobile terminal linked to the vehicle, as a result of which the “deactivated” vehicle function, in a user-specific manner, cannot be operated using the operator electronic control unit; and/or
data relating to vehicle functions that are enabled and/or installed in a functional unit of the vehicle at a later time (“functions on demand”) and can be operated using the operator electronic control unit; and/or
other data that can influence a scope of functions of vehicle functions that can be operated using the operator electronic control unit.

The aforementioned data may be stored in a memory unit in the vehicle. In addition or alternatively, at least some of the aforementioned data can be called from a backend once and/or periodically by the vehicle and stored in a memory unit in the vehicle. To this end, the apparatus or the vehicle comprising apparatus can comprise a communication unit.

The backend can comprise at least one backend server and/or may be part of cloud computing or an IT infrastructure that provides storage space, computing power and/or application software over the Internet as a service (service provider). The backend can comprise backend servers and/or cloud computing or IT infrastructures of a or various service provider(s).

The communication unit may be a communication unit arranged in the apparatus, or in the vehicle, that is configured to set up a communication connection to other communication subscribers, for example the backend and/or a mobile terminal. The communication unit can comprise a subscriber identity module or a SIM card that is used to set up a communication connection via a mobile radio system. The subscriber identity module uniquely identifies the communication unit in the mobile radio network. The communication connection can be a data connection (e.g. packet switching) and/or a circuit-based communication connection (e.g. circuit switching). The communication can take place according to the Cellular Vehicle To X (C-V2X) paradigm based on LTE standard version 14, the 4G standard and/or the 5G standard. In addition, or alternatively, the communication unit can communicate via a different air interface, for example WLAN, independently of the mobile radio network or the availability of sufficient capacities of the currently available mobile radio network. The vehicle can therefore use the communication unit to receive data from other communication subscribers or to transfer data to other communication subscribers.

The electronic control unit is also configured to ascertain operating parameters of the vehicle that can influence an availability of at least one vehicle function that is part of the ascertained scope of functions of the vehicle. The operating parameters may be predefinable or predefined.

The electronic control unit is configured to ascertain a current or up-to-date functional state of the operator electronic control unit from the ascertained scope of functions of the vehicle and the ascertained operating parameters that can influence an availability of at least one vehicle function that is part of the ascertained scope of functions of the vehicle, the functional state of the operator electronic control unit being able to comprise the set of all vehicle functions that can be operated at the given time.

The electronic control unit is configured to control the operator electronic control unit in such a way that the ascertained current functional state can be output, or is output, by the operator electronic control unit.

The output of the current functional state by the operator electronic control unit can comprise in particular outputting or displaying operator control elements of the operator electronic control unit that facilitate operation of a particular one of the vehicle functions that are part of the ascertained functional state of the operator electronic control unit.

Advantageously, the intelligent control of the output elements of the operator electronic control unit, or the intelligent display of only the vehicle functions that are part of the ascertained scope of functions of the operator electronic control unit, allows an up-to-date output or display of operator control elements that facilitate the operation of currently available vehicle functions using the operator electronic control unit to be provided on the operator electronic control unit. Vehicle functions that are not part of the ascertained, up-to-date functional state of the operator electronic control unit are therefore not output or displayed by the operator electronic control unit. The intelligent control of the operator electronic control unit therefore allows a single operator electronic control unit to be provided that represents every possible combination of vehicle functions that can be operated using the operator electronic control unit, resulting in cost advantages when manufacturing operator electronic control units. The deliberate display or output of just those vehicle functions that can be operated using the operator electronic control unit at the given time increases clarity for the user, in particular the driver of the vehicle, thereby reducing the effort for “looking” for the correct operator control element for operating a specific vehicle function. In other words, the driver of the vehicle can use the operator control elements of the operator electronic control unit that are displayed in this manner to obtain an exact overview of the currently operable scope of functions of the vehicle—corresponding to the ascertained functional state—as quickly as possible. This allows the driver to concentrate on the road traffic, thereby increasing safety in road traffic. This approach also contributes to improved user comprehension and to an aesthetic product design.

Preferably, the ascertainment of the scope of functions of the vehicle by the electronic control unit comprises ascertaining vehicle functions that are available in the vehicle and can be operated by way of the operator electronic control unit.

The scope of functions of the vehicle comprises those vehicle functions that can be operated using the operator electronic control unit. By way of example, the scope of functions can be dependent on an equipment for vehicle functions that are provided from the factory (selection of vehicle functions during vehicle configuration). In addition, or alternatively, the scope of functions can be dependent on a specific country or a specific geographical region or a specific market in which vehicle functions are not available, for example due to legal prerequisites or market-specific requirements. By way of example, a parking assistance function or parking maneuver function may not be desirable as a vehicle function in a specific market, as a result of which said functions are not included in the scope of functions of the vehicle in this market. In another example, a speed limit function may not be desirable as a vehicle function in a specific market, as a result of which said function is not included in the scope of functions of the vehicle in this market. Provided that specific safety requirements or safety classifications that apply to the particular market (e.g. Euro NCAP) are not influenced by the omission of a vehicle function, the scope of functions of the vehicle can therefore be adapted in a market-specific manner. In addition, the scope of functions comprises those vehicle functions that have been installed and/or activated in the vehicle at a later time (“functions on demand”), at a time after the time of delivery of the vehicle from the factory. In addition, the scope of functions can cover those vehicle functions that, although fundamentally available in the vehicle, have been deactivated by the user of the vehicle actively or on request, for example because the user of the vehicle does not wish to use these vehicle functions.

Advantageously, a scope of functions of the vehicle can therefore be ascertained that are able to be taken into account regional differences relating to an availability of vehicle functions and/or vehicle functions installed and/or activated at a later time (“functions on demand”) and/or vehicle functions that comprise an equipment of the vehicle from the factory and/or vehicle functions that have been deactivated by the user of the vehicle—on request—at any given time.

Preferably, the ascertainment of the operating parameters that can influence an availability of at least one vehicle function comprises:
ascertaining a current geographical position of the vehicle; and/or
ascertaining a currently used route section; and/or
ascertaining a current speed of the vehicle; and/or
ascertaining a currently activated vehicle function; and/or
ascertaining any operating parameter of the vehicle that is suitable for influencing an availability of at least one vehicle function.

The (current) geographical position of the vehicle can be detected for example by an on-vehicle navigation system or navigation module and/or by a navigation system of a mobile terminal coupled to the vehicle. The navigation system can detect or ascertain the geographical position of the vehicle or of the mobile terminal by ascertaining or capturing current position data using a navigation satellite system. The navigation satellite system can be any established and also future global navigation satellite system (GNSS) for position determination and navigation by receiving the signals from navigation satellites and/or pseudolites. In the example, it may be the Global Positioning System (GPS), GLObal NAvigation Satellite System (GLONASS), Galileo positioning system and/or BeiDou navigation satellite system. In the example of GPS, the navigation system can comprise a GPS module configured to ascertain current GPS position data for the vehicle or the mobile terminal coupled to the vehicle. The electronic control unit may be configured to access the current geographical position thus detected.

The availability of vehicle functions can be dependent on a current geographical position of the vehicle, for example a market-specific vehicle function.

The ascertainment of a currently used route section by the electronic control unit can be ascertained for example using the on-vehicle navigation system. The availability of vehicle functions can be dependent on a currently used route section, for example a driver assistance system comprising a level of automation corresponding to SAE level 3 of SAE standard J3016, which is provided only on predeterminable or predetermined freeway sections.

The ascertainment of a current speed of the vehicle by the electronic control unit can be effected in any conventional manner known from the prior art. The availability of vehicle functions can be dependent on a current vehicle speed, for example a general or arbitrary driver assistance function as a vehicle function.

The ascertainment of a currently activated vehicle function by the electronic control unit can be effected in any conventional manner known from the prior art. An already activated vehicle function leads to said vehicle function no longer being able to be activated, but being able to be deactivated. Such a state can be considered when the current functional state is ascertained by the electronic control unit, and can be output by the operator electronic control unit as appropriate, as explained in more detail later on with reference to FIGS. 2D and 2G, for example.

According to a second aspect, the underlying object is achieved by a vehicle comprising an apparatus.

According to a third aspect, the underlying object is achieved by a method for dynamically matching an operator electronic control unit of a vehicle to a current functional state of vehicle functions of the vehicle, comprising:
ascertaining, using an electronic control unit, a scope of functions of the vehicle;
ascertaining, using the electronic control unit, operating parameters of the vehicle that can influence an availability of at least one vehicle function that is part of the ascertained scope of functions of the vehicle;
ascertaining, using the electronic control unit, a current functional state of the operator electronic control unit from the ascertained scope of functions and the operating parameters; and
controlling, using the electronic control unit, the operator electronic control unit in such a way that the ascertained functional state can be output by the operator electronic control unit.

Preferably, the ascertainment of the scope of functions of the vehicle comprises ascertaining vehicle functions that are available in the vehicle and can be operated by way of the operator electronic control unit.

Preferably, the ascertainment of the operating parameters that can influence an availability of at least one vehicle function comprises:
ascertaining a current geographical position of the vehicle; and/or
ascertaining a currently used route section; and/or
ascertaining a current speed of the vehicle; and/or
ascertaining a currently activated vehicle function; and/or
ascertaining any operating parameter of the vehicle that is suitable for influencing an availability of at least one vehicle function.

According to a fourth aspect, the underlying object is achieved by a computer program product containing program code, configured to perform the method when executed on a computing unit.

According to a fifth aspect, the underlying object is achieved by a non-transitory, computer-readable medium containing program code of a computer program configured to perform the method when executed on a computing unit.

These and other objects, features and advantages of the present subject matter will become clear from studying the detailed description of preferred examples that follows and the accompanying figures. It is obvious that—although examples are described separately—individual features therefrom can be combined to produce additional examples.

Other objects, advantages and novel features of the present subject matter will become apparent from the following detailed description of one or more preferred examples when considered in conjunction with the accompanying drawings.

### BRIEF DESCRIPTION OF THE DRAWINGS

FIG. 1 schematically shows an apparatus for dynamically matching an operator electronic control unit of a vehicle to a current functional state of vehicle functions of the vehicle;

FIG. 2A shows an illustrative operator electronic control unit in the vehicle;

FIG. 2B-2G show an illustrative operator electronic control unit of a vehicle that is dynamically matched to a current functional state of vehicle functions of the operator electronic control unit;

FIG. 3 shows a method for dynamically matching an operator electronic control unit of a vehicle to a current functional state of vehicle functions of the vehicle.

### DETAILED DESCRIPTION OF THE DRAWINGS

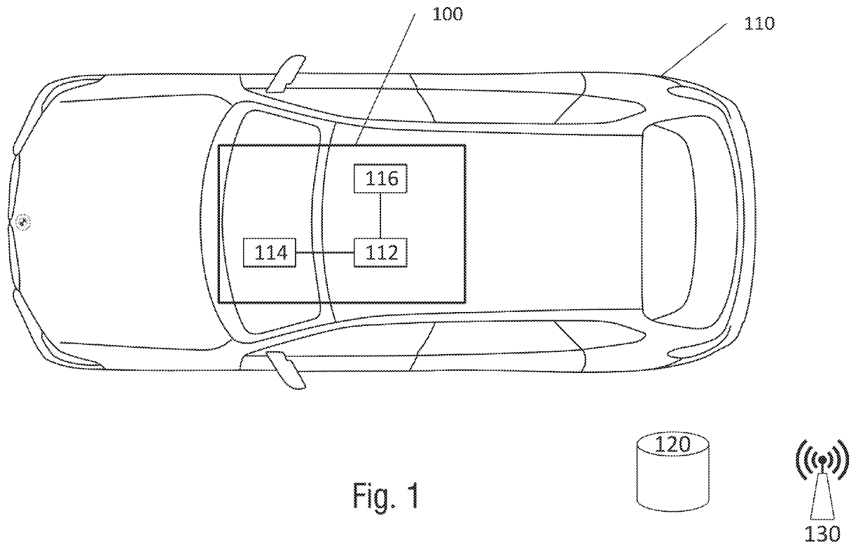

FIG. 1 schematically shows a vehicle 110 comprising an apparatus 100 for dynamically matching an operator electronic control unit 114 of the vehicle 110 to a current functional state of vehicle functions of the vehicle 110 that can be operated by way of operator control elements 210, 220, 230, 240, 250, 260 of the operator electronic control unit.

The apparatus 100 comprises an electronic control unit 112. The electronic control unit 112 is configured to ascertain a scope of functions of the vehicle 110. The scope of functions of the vehicle 110 can comprise all vehicle functions that are available in the vehicle and can be operated by way of the operator electronic control unit.

The scope of functions of the vehicle 110 comprises those vehicle functions that, available in the vehicle, can be operated using the operator electronic control unit 114. By way of example, the scope of functions can be dependent on an equipment for vehicle functions that are provided from the factory (selection of vehicle functions during vehicle configuration). In addition, or alternatively, the scope of functions can be dependent on a specific country or a specific geographical region or a specific market in which for example vehicle functions are not available due to legal prerequisites or market-specific requirements. By way of example, a parking assistance function or parking maneuver function may not be desirable as a vehicle function in a specific market, as a result of which said functions are not included in the scope of functions of the vehicle in this market. In another example, a speed limit function may not be desirable as a vehicle function in a specific market, as a result of which said function is not included in the scope of functions of the vehicle in this market. Provided that specific safety requirements or safety classifications that apply to the particular market (e.g. Euro NCAP) are not influenced by the omission of a vehicle function, the scope of functions of the vehicle 110 can therefore be adapted in a market-specific manner. In addition, the scope of functions comprises those vehicle functions that have been installed and/or activated in the vehicle 110 at a later time (“functions on demand”), at a time after the time of delivery of the vehicle from the factory. In addition, the scope of functions can cover those vehicle functions that are fundamentally available in the vehicle 110 but have been deactivated by the user of the vehicle 110 actively or on request, for example because the user of the vehicle 110 does not wish to use these vehicle functions.

The scope of functions of the vehicle 110 can be ascertained from a large volume of data. The data can comprise:
data relating to an equipment for vehicle functions of the vehicle 110 that are present in the vehicle 110 from the factory and can be operated using the operator electronic control unit 114; and/or
data relating to a market-specific configuration of vehicle functions of the vehicle 110 that can be operated using the operator electronic control unit 114; and/or
data relating to a user-specific availability of vehicle functions of the vehicle 110 that can be operated using the operator electronic control unit 114, a user of a vehicle 110 being able to “deactivate” a vehicle function that is present or available in the vehicle but that he does not wish to use, for example using an input and output unit in the vehicle 110 and/or using an application that can be loaded and executed by a mobile terminal linked to the vehicle 110, as a result of which the “deactivated” vehicle function, in a user-specific manner, is not output by the operator electronic control unit 114, or the applicable operator control element of the operator electronic control unit 114 is not output or displayed; and/or
data relating to vehicle functions that are enabled and/or installed in a functional unit of the vehicle 110 at a later time (“functions on demand”) and can be operated using the operator electronic control unit 114; and/or
other data that can influence a scope of functions of vehicle functions that can be operated using the operator electronic control unit 114.

The aforementioned data may be stored in a memory unit in the vehicle 110. In addition, or alternatively, at least some of the aforementioned data can be called from a backend 120 once and/or periodically by the vehicle 110 and stored in a memory unit in the vehicle 110. To this end, the apparatus 100 or the vehicle 110 comprising the apparatus can comprise a communication unit 116. The communication unit 116 may be configured to set up a communication connection to other communication subscribers, for example the backend 120 and/or a mobile terminal. The communication unit 116 can comprise a subscriber identity module or a SIM card that is used to set up a communication connection via a mobile radio system 130. The vehicle 110 or the apparatus 100 can therefore use the communication unit 116 to receive data from other communication subscribers or to transfer data to other communication subscribers.

Advantageously, a scope of functions of the vehicle 110 can therefore be ascertained that takes account of regional differences relating to an availability of vehicle functions and/or vehicle functions installed and/or activated at a later time (“functions on demand”) and/or vehicle functions that comprise an equipment of the vehicle 110 from the factory and/or vehicle functions that have been deactivated by the user of the vehicle 110—on request—at any given time.

The electronic control unit 112 is also configured to ascertain operating parameters of the vehicle that can influence availability of at least one vehicle function that is part of the ascertained scope of functions of the vehicle 110. The operating parameters may be predefinable or predefined.

The ascertainment, by the electronic control unit 112, of the operating parameters that influence an availability of at least one vehicle function can comprise:
ascertaining a current geographical position of the vehicle 110; and/or
ascertaining a route section currently used by the vehicle 110; and/or
ascertaining a current speed of the vehicle 110; and/or
ascertaining a currently activated vehicle function; and/or
ascertaining any operating parameter of the vehicle 110 that is suitable for influencing an availability of at least one vehicle function.

The (current) geographical position of the vehicle 110 can be detected for example by an on-vehicle navigation system or navigation module and/or by a navigation system of a mobile terminal coupled to the vehicle 110. The navigation system can detect or ascertain the geographical position of the vehicle 110 or of the mobile terminal by ascertaining or capturing current position data using a navigation satellite system.

The availability of vehicle functions can be dependent on a current geographical position of the vehicle 110, for example a market-specific vehicle function that is available or can be activated only in one or more predeterminable or predetermined markets.

The ascertainment of a currently used route section by the electronic control unit 112 can be ascertained for example using the on-vehicle navigation system. The availability of vehicle functions can be dependent on a currently used route section, for example a driver assistance system comprising a level of automation corresponding to SAE level 3 of SAE standard J3016, which is provided only on predeterminable or predetermined freeway sections.

The ascertainment of a current speed of the vehicle 110 by the electronic control unit 112 can be effected in any conventional manner known from the prior art. The availability of vehicle functions can be dependent on a current vehicle speed, for example a general or arbitrary driver assistance function as a vehicle function.

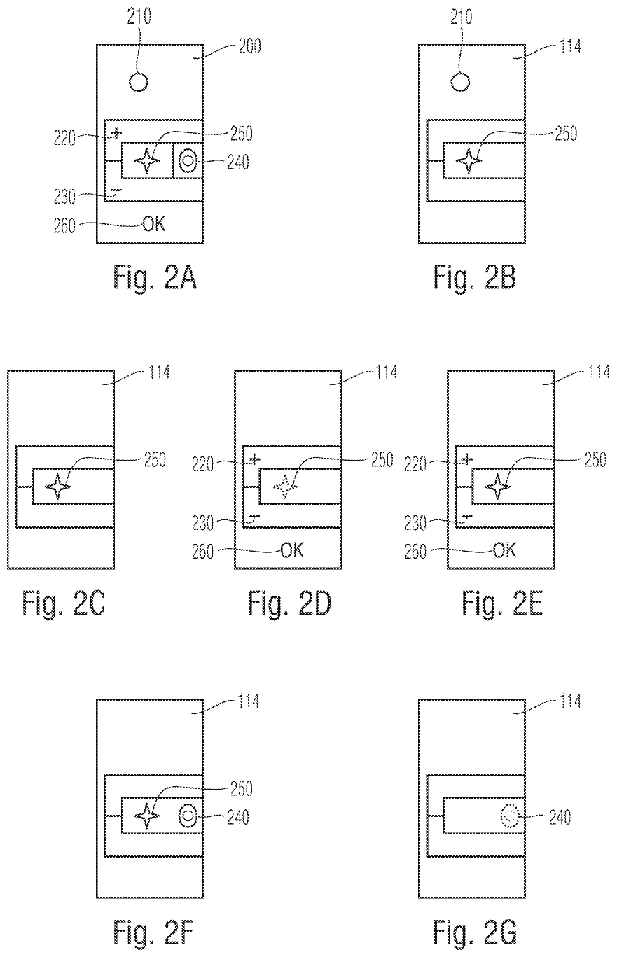

The ascertainment of a currently activated vehicle function by the electronic control unit 112 can be effected in any conventional manner known from the prior art. An already activated vehicle function leads to said vehicle function no longer being able to be activated, but possibly being able to be deactivated. Such a state can be considered when the current functional state is ascertained by the electronic control unit 112, and can be output by the operator electronic control unit 114 as appropriate, as explained in more detail later on with reference to FIGS. 2D and 2G, for example.

The electronic control unit 112 is configured to ascertain a current or up-to-date functional state of the operator electronic control unit 114 from the ascertained scope of functions of the vehicle 110 and the ascertained operating parameters that can influence an availability of at least one vehicle function that is part of the ascertained scope of functions of the vehicle 110.

The electronic control unit 112 is configured to control the operator electronic control unit 114 in such a way that the ascertained current functional state can be output, or is output, by the operator electronic control unit 114.

The output of the current functional state by the operator electronic control unit 114 can comprise in particular outputting or displaying operator control elements of the operator electronic control unit 114 that facilitate operation of a particular one of the vehicle functions that are part of the ascertained functional state of the operator electronic control unit 114, as explained in more detail by way of illustration later on with reference to FIGS. 2B to 2G.

Advantageously, the intelligent control of the output elements of the operator electronic control unit 114, or the intelligent display of only the vehicle functions that are part of the ascertained scope of functions of the operator electronic control unit 114, allows an up-to-date output or display of operator control elements that facilitate the operation of currently available vehicle functions using the operator electronic control unit 114 to be provided on the operator electronic control unit 114. Vehicle functions that are not part of the ascertained, up-to-date functional state of the operator electronic control unit 114 are therefore not output or displayed by the operator electronic control unit 114. The intelligent control of the operator electronic control unit 114 therefore allows a single operator electronic control unit 114 to be provided that represents every possible combination of vehicle functions that can be operated or activated or deactivated using the operator electronic control unit 114, resulting in considerable cost advantages when manufacturing operator electronic control units. The deliberate display or output of just those vehicle functions that can be operated using the operator electronic control unit 114 at the given time increases clarity for the user, in particular the driver of the vehicle 110, thereby reducing the effort for “looking” for the correct operator control element for operating a specific vehicle function. In other words, the driver of the vehicle 110 can use the operator control elements of the operator electronic control unit 114 that are displayed in this manner to obtain an exact overview of the currently operable scope of functions of the vehicle—corresponding to the ascertained functional state—as quickly as possible. This allows the driver to concentrate on the road traffic, thereby increasing safety in road traffic. This approach also contributes to improved user comprehension and to an aesthetic product design.

FIG. 2A shows an illustrative operator electronic control unit 200 of a vehicle for the purpose of illustration. The operator electronic control unit 200 comprises
a first operator control element 210, which can be used to operate a general or arbitrary driver assistance system of the vehicle 110;
a second operator control element 220 and a third operator control element 230, which can be used to alter a set speed of a cruise control in the vehicle 110, the set speed being able to be increased using the operator control element 220 and being able to be decreased using the operator control element 230;
a fourth operator control element 240, which can be used to operate a driver assistance system comprising a level of automation corresponding to SAE level 3 of SAE standard J3016;
a fifth operator control element 250, which can be used to operate a driver assistance system comprising a level of automation corresponding to SAE level 2 of SAE standard J3016; and
a sixth operator control element 260, which can be used to confirm a set speed that has been selected using the second and/or third operator control element 220, 230.

The operator control elements 210, 220, 230, 240, 250 and 260 of the operator electronic control unit 220 are visible to the user at any given time, irrespective of a current possibility of operating the applicable operator control function.

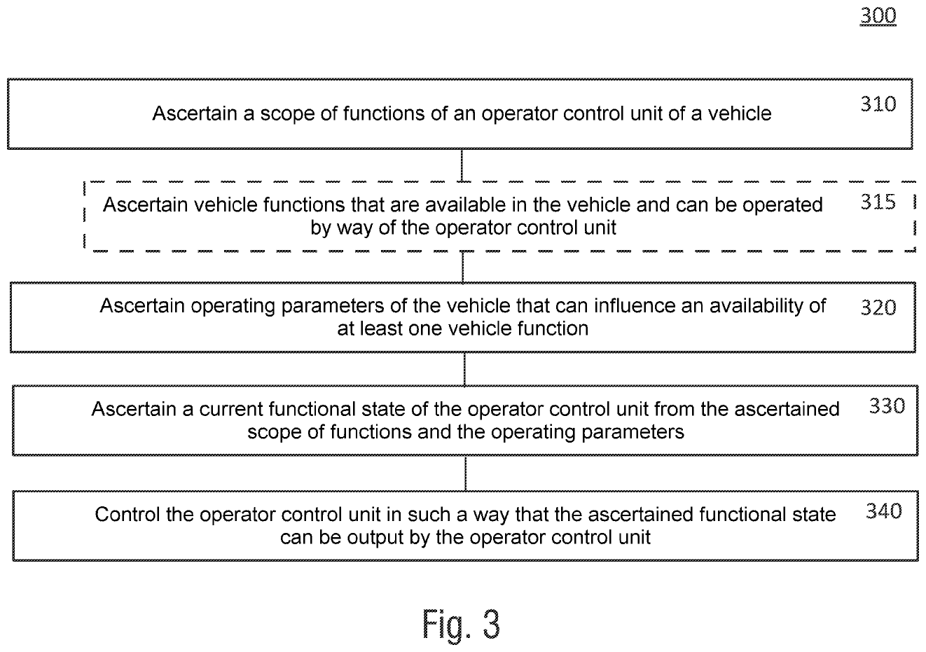

FIGS. 2B to 2G show an illustrative operator electronic control unit 114 of a vehicle 110 for the purpose of illustration, which operator electronic control unit, for the sake of clarity, comprises the same operator control elements 210, 220, 230, 240, 250 and 260 as the operator electronic control unit 200, but—as described with reference to FIGS. 1 and 3—is dynamically matched to a current functional state of vehicle functions of the vehicle.

FIG. 2B shows the operator electronic control unit 114 at the start of a journey in the vehicle 110. The current functional state of the operator electronic control unit 114 ascertained by the electronic control unit 112—as described with reference to FIG. 1—comprises the vehicle functions:
driver assistance system comprising a level of automation corresponding to SAE level 2 of SAE standard J3016, which can be operated or selected or activated by way of the operator control element 250; and
a general driver assistance system of the vehicle 110 that can be operated or selected or activated by way of the operator control element 210.

The electronic control unit 112 controls the operator electronic control unit 114 in such a way that the ascertained current functional state of the vehicle 110 is output by the operator electronic control unit. In this example, this leads to only the operator control elements 210 and 250 being output or displayed by the operator electronic control unit 114.

FIG. 2C shows the operator electronic control unit 114 after the start of the journey as described with reference to FIG. 2B. The current functional state of the operator electronic control unit 114 ascertained by the electronic control unit 112—as described with reference to FIG. 1—comprises the vehicle function ‘driver assistance system comprising a level of automation corresponding to SAE level 2 of SAE standard J3016’, which can be operated or selected or activated by way of the operator control element 250.

The general driver assistance system of the vehicle 110 that can be operated or selected or activated by way of the operator control element 210 is no longer part of the functional state of the operator electronic control unit 114, since a predetermined maximum speed for activating the general driver assistance system has been exceeded.

The electronic control unit 112 controls the operator electronic control unit 114 in such a way that the ascertained current functional state of the vehicle 110 is output by the operator electronic control unit. In this example, this leads to only the operator control element 250 being output or displayed by the operator electronic control unit 114.

FIG. 2D shows the operator electronic control unit 114 after the vehicle function ‘driver assistance system comprising a level of automation corresponding to SAE level 2 of SAE standard J3016’, as shown in FIG. 2C, has been activated by the driver of the vehicle using the applicable operator control element 250. The electronic control unit 112 now ascertains the functional state of the operator electronic control unit as being that the activated driver assistance system cannot be activated, but can be deactivated using the same operator control element 250. In addition, the current functional state ascertained is that a set speed of the activated driver assistance system can be increased or decreased using the operator control elements 220 and 230. Furthermore, the current functional state ascertained is that a potential increase or decrease of the set speed of the activated driver assistance system using the operator control element 220 or 230 can be confirmed using the operator control element 260. The current functional state of the operator electronic control unit 114 ascertained by the electronic control unit 112—as described with reference to FIG. 1—therefore comprises deactivation of the activated driver assistance system by way of the operator control element 250, increase or decrease of the set speed of the activated driver assistance system by way of the operator control elements 220 and 230 and confirmation of an increase or decrease of the set speed of the activated driver assistance system using the operator control elements 220 and 230 by way of the operator control element 260.

The electronic control unit 112 controls the operator electronic control unit 114 in such a way that the ascertained current functional state of the vehicle 110 is output by the operator electronic control unit. In this example, this leads to the operator control elements 220, 230, 250 and 260 being output or displayed by the operator electronic control unit 114, the display or output of the operator control element 250 for deactivating the activated driver assistance system differing from the display or output for activating the unactivated driver assistance system in the representation of the operator control element 250 (e.g. change of contours of the operator control element 250 and/or of a color of the operator control element 250).

FIG. 2E shows the operator electronic control unit 114 after the vehicle function ‘driver assistance system comprising a level of automation corresponding to SAE level 2 of SAE standard J3016’, as shown in FIG. 2D, has been activated by the driver of the vehicle using the applicable operator control element 250, but has been put into a standby mode as a result of manual intervention by the driver of the vehicle 110, for example as a result of manual braking. The electronic control unit 112 now ascertains the functional state of the operator electronic control unit as being that the driver assistance system in the standby mode can be reactivated using the operator control element 250. In addition, the current functional state ascertained is that a change of set speed of the driver assistance system in the standby mode by operating the operator control elements 220 and 230 (increase or decrease the set speed) can be used to reactivate the driver assistance system. The current functional state of the operator electronic control unit 114 ascertained by the electronic control unit 112—as described with reference to FIG. 1—therefore comprises reactivation of the driver assistance system in the standby mode by way of the operator control element 250 and increase or decrease of the set speed of the driver assistance system in the standby mode by way of the operator control elements 220 and 230. Furthermore, the current functional state ascertained is that a potential increase or decrease of the set speed of the driver assistance system in the standby mode using the operator control element 220 or 230 can be confirmed using the operator control element 260.

The electronic control unit 112 controls the operator electronic control unit 114 in such a way that the ascertained current functional state of the vehicle 110 is output by the operator electronic control unit. In this example, this leads to the operator control elements 220, 230, 250 and 260 being output or displayed by the operator electronic control unit 114, the display or output of the operator control element 250 for reactivating the driver assistance system in the standby mode corresponding to the display or output for activating the unactivated driver assistance system.

FIG. 2F shows the operator electronic control unit 114 for which the vehicle 110 is on a route section for which, in addition to the driver assistance system based on SAE level 2 of SAE standard J3016, which is inactive and can be activated using the applicable operator control element 250, also a driver assistance system based on SAE level 3 of SAE standard J3016, which is inactive, and can be activated using the applicable operator control element 240. The electronic control unit 112 now ascertains the functional state of the operator electronic control unit as being that the driver assistance system based on SAE level 2 of SAE standard J3016 and the driver assistance system based on SAE level 3 of SAE standard J3016 can be activated.

The electronic control unit 112 controls the operator electronic control unit 114 in such a way that the ascertained current functional state of the vehicle 110 is output by the operator electronic control unit. In this example, this leads to the operator control elements 240 and 250 being output or displayed by the operator electronic control unit 114, the display or output of the operator control elements 240 and 250 also clearly showing, by way of a specific representation of the operator control elements 240, 250 (e.g change of contours of the operator control elements 240, 250 and/or of a color of the operator control elements 240, 250), that both driver assistance systems are deactivated and can only be activated.

FIG. 2G shows the operator electronic control unit 114 for which the vehicle 110 is on a route section for which the driver assistance system based on SAE level 3 of SAE standard J3016 can be activated and is activated, and can be deactivated using the applicable operator control element 240. The electronic control unit 112 now ascertains the functional state of the operator electronic control unit as being only the vehicle function “Deactivation of the driver assistance system based on SAE level 3 of SAE standard J3016” using the operator control element 240.

The electronic control unit 112 controls the operator electronic control unit 144 in such a way that the ascertained current functional state of the vehicle 110 is output by the operator electronic control unit 114. In this example, this leads to the operator control element 240 being output or displayed by the operator electronic control unit 114, the display or output of the operator control element 240 also clearly showing in the representation of the operator control element 240 (e.g. change of contours of the operator control element 240 and/or of a color of the operator control element 250) that the driver assistance system based on SAE level 3 of SAE standard J3016 is active and can only be deactivated and therefore differs from the output or display of the operator control element 240 as described with reference to FIG. 2F.

The term module (and other similar terms such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

FIG. 3 shows a method 300 for dynamically matching an operator electronic control unit 114 of a vehicle 110 to a current functional state of vehicle functions 210, 220, 230, 240, 250, 260, 270, 280 of the vehicle 110. The method 300 can be carried out by an apparatus 100 as described with reference to FIG. 1.

The method 300 comprises:
ascertaining 310, using an electronic control unit 112, a scope of functions of the vehicle 110;
ascertaining 320, using the electronic control unit 112, operating parameters of the vehicle 110 that can influence an availability of at least one vehicle function 210, 220, 230, 240, 250, 260, 270, 280 that is part of the ascertained scope of functions of the vehicle 110;
ascertaining 330, using the electronic control unit 112, a current functional state of the operator electronic control unit 114 from the ascertained scope of functions and the operating parameters; and
controlling 340, using the electronic control unit 112, the operator electronic control unit 114 in such a way that the ascertained functional state can be output by the operator electronic control unit 114.

The ascertainment of the scope of functions of the vehicle 110 can comprise ascertaining vehicle functions 210, 220, 230, 240, 250, 260, 270, 280 that are available in the vehicle 110 and can be operated by way of the operator electronic control unit 114.

The ascertainment of the operating parameters that can influence an availability of at least one vehicle function 210, 220, 230, 240, 250, 260, 270, 280 can comprise:
ascertaining a current geographical position of the vehicle 110; and/or
ascertaining a currently used route section; and/or
ascertaining a current speed of the vehicle 110; and/or
ascertaining a currently activated vehicle function 210, 220, 230, 240, 250, 260, 270, 280; and/or
ascertaining any operating parameter of the vehicle 110 that is suitable for influencing an availability of at least one vehicle function 210, 220, 230, 240, 250, 260, 270, 280.

FIG. 3 shows a method 300 for dynamically matching an operator electronic control unit 114 of a vehicle 110 to a current functional state of vehicle functions 210, 220, 230, 240, 250, 260, 270, 280 of the vehicle 110. The method 300 can be carried out by an apparatus 100 as described with reference to FIG. 1.

The foregoing disclosure has been set forth merely to illustrate the present subject matter and is not intended to be limiting. Since modifications of the disclosed examples incorporating the spirit and substance of the present subject matter may occur to persons skilled in the art, the present subject matter should be construed to include everything within the scope of the appended claims and equivalents thereof.

1. An apparatus for dynamically matching an operator electronic control unit of a vehicle to a current functional state of vehicle functions of the vehicle, comprising:
an electronic control unit configured to:
ascertain a scope of functions of the vehicle;
ascertain operating parameters of the vehicle that can influence an availability of at least one vehicle function that is part of the ascertained scope of functions of the vehicle;
ascertain a current functional state of the operator electronic control unit from the ascertained scope of functions and the operating parameters; and
control the operator electronic control unit in such a way that the ascertained functional state can be output by the operator electronic control unit.

2. The apparatus according to claim 1, wherein the ascertainment of the scope of functions of the vehicle comprises:
ascertaining vehicle functions that are available in the vehicle and can be operated by way of the operator electronic control unit.

3. The apparatus according to claim 2, wherein the ascertainment of the operating parameters that can influence an availability of at least one vehicle function comprises:
ascertaining a current geographical position of the vehicle;
ascertaining a currently used route section;
ascertaining a current speed of the vehicle;
ascertaining a currently activated vehicle function; and/or
ascertaining any operating parameter of the vehicle that is suitable for influencing an availability of at least one vehicle function.

4. A vehicle comprising the apparatus according to claim 1.

5. A method for dynamically matching an operator electronic control unit of a vehicle to a current functional state of vehicle functions of the vehicle, comprising:
ascertaining, using an electronic control unit, a scope of functions of the vehicle;
ascertaining, using the electronic control unit, operating parameters of the vehicle that can influence an availability of at least one vehicle function that is part of the ascertained scope of functions of the vehicle;
ascertaining, using the electronic control unit, a current functional state of the operator electronic control unit from the ascertained scope of functions and the operating parameters; and
controlling, using the electronic control unit, the operator electronic control unit in such a way that the ascertained functional state can be output by the operator electronic control unit.

6. The method according to claim 5, wherein the ascertainment of the scope of functions of the vehicle comprises ascertaining vehicle functions that are available in the vehicle and can be operated by way of the operator electronic control unit.

7. The method according to claim 5, wherein the ascertainment of the operating parameters that can influence an availability of at least one vehicle function comprises:
ascertaining a current geographical position of the vehicle;
ascertaining a currently used route section;
ascertaining a current speed of the vehicle;
ascertaining a currently activated vehicle function; and/or
ascertaining any operating parameter of the vehicle that is suitable for influencing an availability of at least one vehicle function.

8. A non-transitory computer-readable medium comprising instructions operable, when executed by one or more computing systems, to perform the method according to claim 5.
